(19) United States
(12) Patent Application Publication
(10) Pub. No.: US 2023/0294108 A1
(43) Pub. Date: Sep. 21, 2023

(54) METHOD AND APPARATUS FOR CENTRIFUGAL SEPARATION OF PARTICLES FROM A GAS FLOW

(71) Applicant: Grimaldi Development AB, Nacka Strand (SE)

(72) Inventors: Claes Inge, Nacka (SE); Peter Franzén, Bandhagen (SE); Carl Petrus Häggmark, Täby (SE)

(21) Appl. No.: 18/040,924

(22) PCT Filed: Aug. 6, 2021
(86) PCT No.: PCT/SE2021/050777

§ 371 Date: Feb. 7, 2023

(30) Foreign Application Priority Data
Aug. 20, 2020 (SE) 2050969-1

(51) Int. Cl. B03C 3/017; B01D 47/06; B01D 45/14; B01D 50/40; B04B 5/10; B01F 31/85

(52) U.S. Cl. CPC B03C 3/017; B01D 45/14; B01D 47/06; B01D 50/40; B01F 31/85; B04B 5/10

(57) ABSTRACT

A method of centrifugal separation of particles, comprising providing a gas flow containing the particles, charging the particles in the gas flow, generating an aerosol of polar liquid droplets introducing the aerosol into the gas flow for attracting the charged particles by the polar liquid droplets, and separating the liquid droplets comprising the attracted particles from the gas flow by the centrifugal separation.

### CROSS-REFERENCE TO RELATED APPLICATION(S)

This present application is a Section 371 National Stage Application of International Application No. PCT/SE2021/050777, filed Aug. 6, 2021 and published as WO 2022/039644 A1 on Feb. 24, 2022, in English, and further claims priority to Swedish patent app. Ser. No. 2050969-1, filed Aug. 20, 2020.

### FIELD OF THE INVENTION

This invention relates to method of centrifugal separation of particles, comprising providing a gas flow containing the particles, and charging the particles in the gas flow.

### BACKGROUND OF THE INVENTION

Small particles in the range of typically about 15-150 nm, such as virus, are too small to be separated by conventional centrifugal separation. A prior art apparatus is disclosed in EP 1 907 124 B2. In this prior art apparatus the gas flow is directed through a charging unit for charging the small particles in order that the particles can be attracted to oppositely charged surface elements in the rotor of a centrifugal separator.

### SUMMARY OF THE INVENTION

Disclosed embodiments of the invention provide an alternative method and apparatus which is capable of effectively separating virus and other small particles by centrifugal separation.

In an aspect of the invention the method further comprises generating an aerosol of polar liquid droplets, introducing the aerosol into the gas flow for attracting the charged particles by the polar liquid droplets, and separating the liquid droplets comprising the attracted particles from the gas flow by the centrifugal separation.

By generating and introducing an aerosol of polar droplets, such as a dense mist of water droplets, into the gas flow, the small charged particles will be mixed with and easily attracted to the substantially larger and more massive polar droplets. The larger droplets may then be easily separated from the gas in the centrifugal separation step, i.e. by using a centrifugal separator that will not need any complicated internal rotary electrostatic charging components.

The aerosol may be generated by vibration of a polar liquid in contact with the gas flow,

The aerosol may also be generated by pressurized atomization of a polar liquid.

While the gas flow and the aerosol may be sufficiently mixed by just uniting the gas flow and aerosol to a joint flow, the mixing may be more thoroughly accomplished by varying a cross section of the gas flow comprising the introduced aerosol.

Thereby the joint flow will be compressed and expanded, and possibly also get turbulent, which will increase the mixing action. Thereby the gas flow will also temporarily slow down which will give sufficient time for the particles to be attracted and captured by the polar droplets in the aerosol.

An apparatus according to the invention comprises in serial fluid interconnection: an electrostatic charging device, a mixing vessel, an aerosol generator in the mixing vessel, and a centrifugal separator.

The present summary is provided only by way of example and not limitation. Other features and advantages of the invention may be apparent from the entirety of the present disclosure, including the claims, the accompanying figures, and the following detailed description.

### BRIEF DESCRIPTION OF THE DRAWING

FIG. 1 is a diagrammatic perspective view of an apparatus according to the invention;

FIG. 2 is a diagrammatic lateral view, mainly in section, of a particle charging device in an apparatus according to the invention;

FIG. 3 is a cross section view taken along line 3-3 in FIG. 2;

FIG. 4 is a diagrammatic lateral view, mainly in section, of a mixing vessel in an apparatus according to the invention;

FIG. 5 is a broken away diagrammatic lateral view, partly in section, showing an alternative embodiment of an aerosol generator according to the invention;

FIG. 6 is a diagrammatic lateral view, partly in section, showing a centrifugal separator according to the invention; and

FIG. 7 is a diagram illustrating principles of the invention.

While the above-identified figures set forth one or more embodiments of the present invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features, steps, and/or components not specifically shown in the drawings.

### DETAILED DESCRIPTION

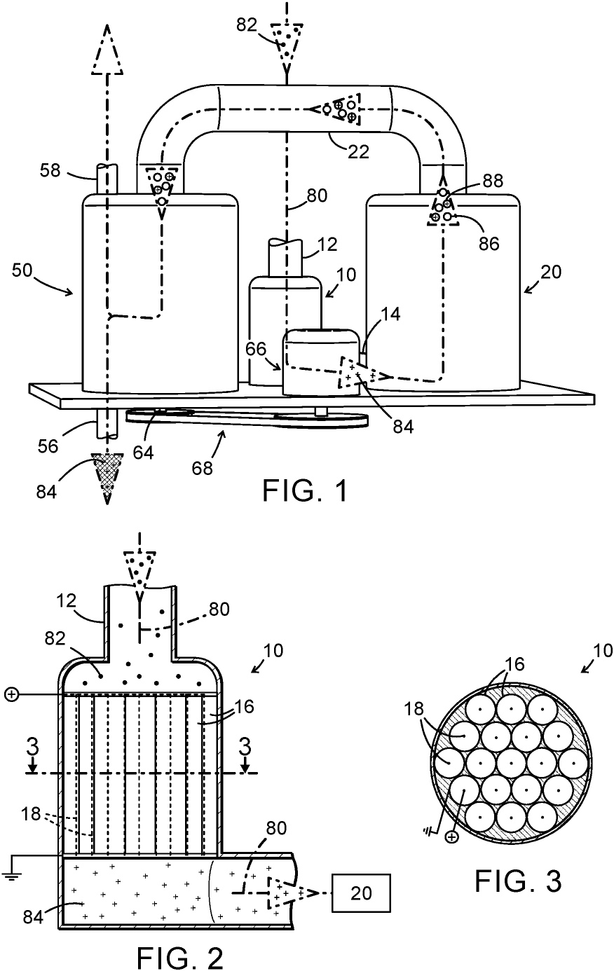

The exemplary apparatus shown in FIG. 1 generally comprises a setup of the following main components: an electrostatic charging device 10, a mixing vessel 20 and a centrifugal separator 50, which are serially interconnected by conduits 14 and 22. Numeral 80 indicates the course of a gas/air flow being processed in the apparatus. The gas flow 80 including small particles 82, typically in the range of 15-150 nm, such as viruses, to be separated, is introduced into the apparatus at an inlet 12 of the charging device 10. The particles finally separated in the apparatus leave the apparatus from a liquid outlet 56 of the centrifugal separator 50, whereas the gas flow free of the particles leaves the apparatus from a gas outlet 58 of the centrifugal separator 50. In the embodiment shown, the gas flow 80 is created by the suction force generated by the centrifugal separator 50.

As also shown in FIG. 1, a motor 66 is provided for rotating a rotor shaft 64 of the centrifugal separator 50 via a transmission 68.

The electrostatic charging device 10 is an ionizing unit in the form of a corona discharge unit arranged for charging the particles in the flow of gas, before they are conveyed to the mixing vessel 20.

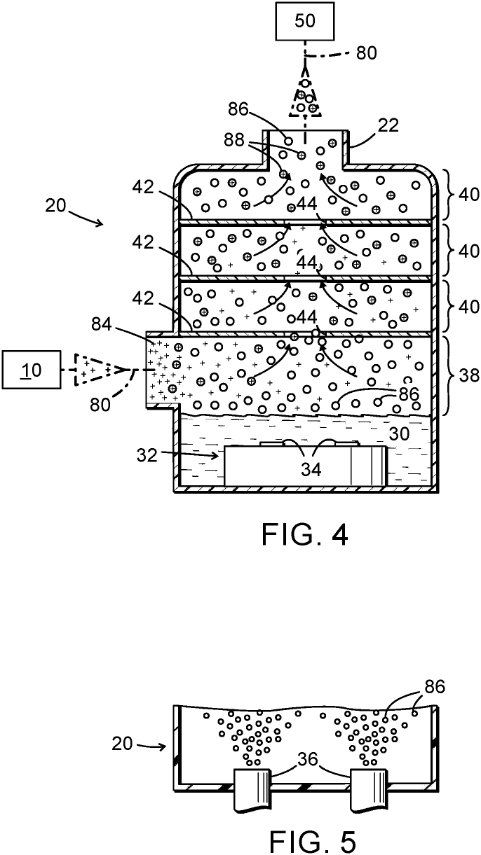

As apparent from FIGS. 2 and 3, the charging device 10 comprises a number of parallel open-ended tubes 14 inserted in the flow for conveying the gas flow therethrough. Each tube 14 has a central corona wire 16 extending through the tube 14. In the shown arrangement each corona wire 16 extends through a respective tube 14 and is connected to a negative or positive voltage potential, for example +10 kV, while the walls of the tubes 14 are of an electrically conductive material and connected to earth. By means of the corona wires 16, the particles 82 in the flow of gas are charged, for example with a positive voltage, to be charged particles 84, indicated as +-symbols in the drawing, when they exit the tubes 14 and are further conveyed by the gas flow 80 into the mixing vessel 20. The mixing vessel 20 is shown in more detail in FIG. 4. In the bottom of the mixing vessel 20, a vibration generator 32 is immersed in a liquid volume 30 which may be water or any suitable polar liquid solution. The vibration generator 32, which may be of a known e.g. piezoelectric type, has vibrating elements 34 positioned at a suitable distance below the surface of the liquid volume to generate a dense or thick aerosol or mist of polar liquid droplets 86 in the gas/air in a premix chamber 38 above the surface of the liquid volume 30. By varying the surface tension and the viscosity of the liquid, a suitable aerosol drop size distribution can be achieved. The droplets must be sufficiently large, in the range of about 1-1.0 µm for being able to be separated in a centrifugal separator. Since such droplets still are considered to be very small, the number of droplets will be very large, resulting in that the distance between them is relatively small, which facilitates the charged particles to be attracted and trapped by the liquid/water droplets.

As the gas flow 80 with charged particles 84 enter the premix chamber and mix with the aerosol therein, the charged particles 84 start to be attracted and captured by the polar droplets 86 in the aerosol.

To enhance the mixing action, in the shown embodiment, the mixing vessel 20, following the premix chamber 38, has a number, for example three, of serially stacked postmix chambers 40 interconnected by central constricting openings 44 in partitions 42 defining the chambers 40. The openings 44 serve to locally accelerate and retard (or compress and expand) the combined flow of gas, droplets and particles, and possibly also introduce turbulence in the flow, to thereby promote the mixing action. In the succession of postmix chambers 40, still uncaptured charged particles 84 will also have sufficient time to eventually be captured by the densely distributed polar droplets 86 in the aerosol. The droplets having captured particles, is hereinafter referred to as “particle droplets” 88.

As Illustrated in FIG. 5, it is also possible to generate the aerosol with one or more suitably configured spray or atomizing nozzles 36, which may use pressurized polar liquid or such liquid together with pressurized gas/air. The droplet size may in this case also be varied in a well-known manner by nozzle design and fluid pressures.

The particle droplets 88 and the remaining polar droplets 86 in the gas flow 80 exit the mixing vessel 20 and are introduced into the centrifugal separator 50 via the conduit 22 (FIG. 1).

The exemplary and diagrammatically illustrated centrifugal separator 50 shown in FIG. 4 has a rotor 60 rotationally journaled in a casing or housing 52. The gas flow 80 enters the separator 50 into a central top inlet 54 in the casing 52 and extends coaxially down to a top face of a frusto-conical base 62 of the rotor 60.

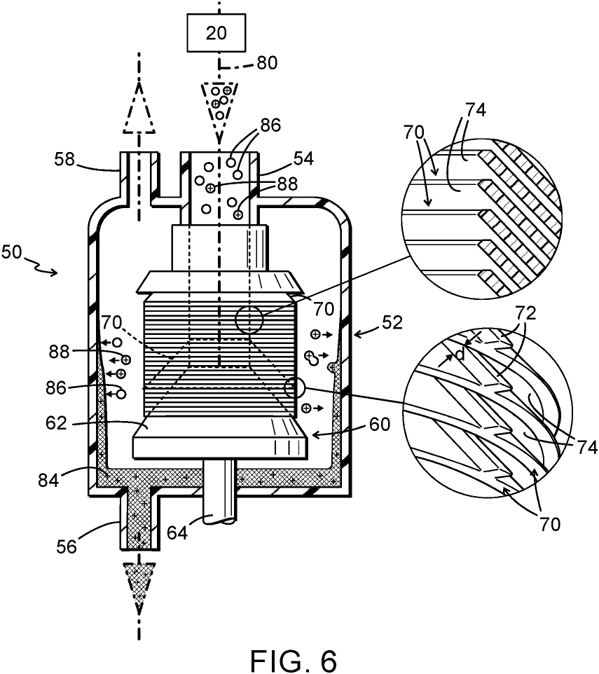

A plurality of frusto-conical open-ended surface elements 70 is stacked onto the base 62. As shown in the enlarged areas of FIG. 6, the surface elements 70 are kept stacked at mutually small distances d by means of suitable spacers 72, for example in the shape of radial flanges formed on the surface elements 70.

When the centrifugal separator 50 is in operation, the droplets 86, 88 in the flow will be sucked into the open center of the rotating stack of surface elements 70 and thrown by centrifugal force against inclined inner faces 74 of the surface elements 70. During continued separator operation, the droplets 86, 88 will accumulate, adhere and/or agglomerate on the inner faces 74 of the surface elements 70, until they are massive enough to be centrifugally thrown radially out of the gaps between the surface elements 70 where after they face the inner wall of the housing 52.

The lighter gas/air free of particles in the flow is forced with overpressure by fan action of the rotating stack of surface elements 70 through a gas outlet 58 of the separator housing 52. The droplets/agglomerates that accumulate on the inner wall of the housing 52 can flow by gravity down the inner wall and exit the separator 50 through a liquid outlet 56 in in the housing 52.

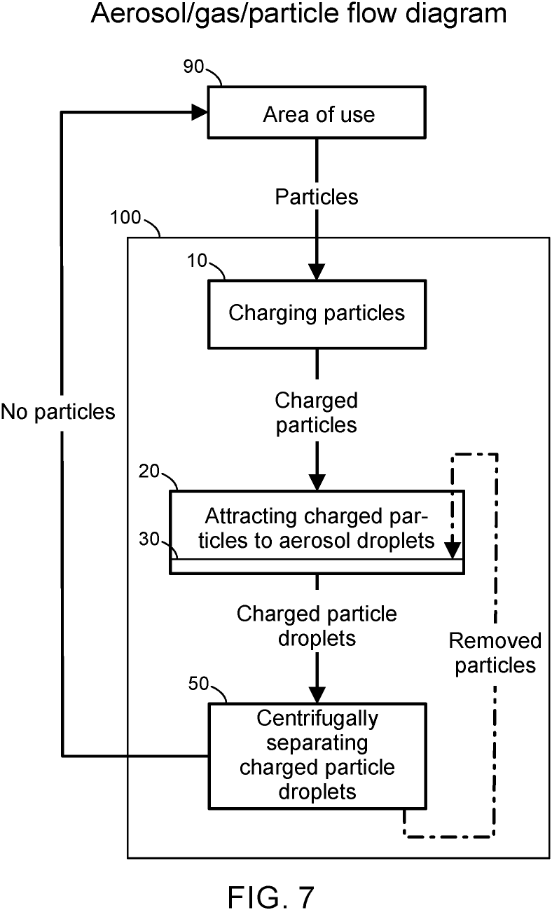

The diagram shown in FIG. 7 illustrates in a self-explaining manner the flow of gas, aerosol and particles in an apparatus according to the invention. Air containing small particles is withdrawn from an area of use 90 into the apparatus. The area of use may generally be an area in a hospital or in an infection clinic, such as operation rooms, isolation rooms etc., and also in other buildings where infection may occur. Air free from the particles may be returned to the area of use. As indicated in FIG. 7, the apparatus may be designed as a self-contained unit 100. In that case the waste liquid containing the removed particles can be returned to the mixing vessel 20. When viruses are separated, they can be killed by virus killing agents in the polar liquid or by heating separated polar liquid to a temperature which the virus particles cannot withstand.

The foregoing detailed description is given primarily for clearness of understanding and no unnecessary limitations are to be understood therefrom. Modifications will become obvious to those skilled in the art upon reading this disclosure and may be made without departing from the scope of the appended claims.

List of numeral references

| | |
|---|---|
| 10 Charging device | 64 Rotor shaft |
| 12 Inlet | 66 Motor |
| 14 Conduit | 68 Transmission |
| 16 Corona wire | 70 Surface element |
| 20 Mixing vessel | 72 Spacer |
| 22 Conduit | 74 Inclined inner face |
| 30 Polar liquid volume | 80 Gas flow |
| 32 Vibration generator | 82 Particle |
| 34 Vibrating elements | 84 Charged particle |
| 36 Spray nozzle | 86 Polar liquid droplet |
| 38 Premix chamber | 88 Particle droplet |
| 40 Postmix chamber | 90 Area of use |
| 42 Partition | 100 Apparatus as self-contained unit |
| 44 Opening | |
| 50 Centrifugal separator | |
| 52 Casing | |
| 54 Central top inlet | |
| 56 Liquid outlet | |
| 58 Gas outlet | |
| 60 Rotor | |
| 62 Base of rotor | |

1. A method of centrifugal separation of particles, comprising:
providing a gas flow containing the particles;
charging the particles in the gas flow;
generating an aerosol of polar liquid droplets;
introducing the aerosol into the gas flow for attracting the charged particles by the polar liquid droplets; and
separating the liquid droplets comprising the attracted particles from the gas flow by the centrifugal separation.

2. The method of claim 1, further comprising generating the aerosol by vibration of a polar liquid in contact with the gas flow.

3. The method of claim 1, further comprising generating the aerosol by pressurized atomization of a polar liquid.

4. The method of claim 1, further comprising varying a cross section of the gas flow comprising the introduced aerosol.

5. An apparatus for performing centrifugal separation of particles, wherein a gas flow is provided containing the particles, comprising in serial fluid interconnection:
an electrostatic charging device for charging the particles in the gas flow;
an aerosol generator for generating an aerosol of polar liquid droplets in a mixing vessel, wherein the aerosol is introduced into the gas flow to attract the charged particles by the polar liquid droplets; and
a centrifugal separator for separating the liquid droplets comprising the attracted particles from the gas flow by centrifugal separation.

6. The apparatus of claim 5, wherein said aerosol generator comprises a vibration generator to generate the aerosol of droplets from a liquid volume occupied in the mixing vessel.

7. The apparatus of claim 5, wherein said aerosol generator comprises an aerosol-forming spray nozzle.

8. The apparatus of claim 5, comprising a constricted opening in a partition of the mixing vessel.

9. The apparatus of claim 8, comprising a plurality of constricted openings in partitions of the mixing vessel.

10. The apparatus of claim 5, comprising a plurality of spaced-apart surfaces in the centrifugal separator to trap and agglomerate liquid droplets and particles separated from the gas flow.

11. The apparatus of claim 8, wherein the mixing vessel comprises a premix chamber housing the aerosol generator.

12. The apparatus of claim 5, wherein the mixing vessel includes a premix chamber housing the aerosol generator, wherein the aerosol generator includes a vibration generator to generate the aerosol of droplets from a liquid volume occupied in the mixing vessel, wherein the centrifugal separator includes a plurality of spaced-apart surfaces to trap and agglomerate liquid droplets and particles separated from a gas flow, and wherein the apparatus further comprises one or more constricted openings in one or more partitions, respectively, of the mixing vessel.

13. A method of centrifugal separation of particles, comprising
providing a gas flow containing the particles;
charging the particles in the gas flow;
generating an aerosol by vibration of a polar liquid in contact with the gas flow;
introducing the aerosol into the gas flow for attracting the charged particles by the polar liquid droplets of the aerosol;
varying a cross section of the gas flow comprising the introduced aerosol; and
separating the liquid droplets comprising the attracted particles from the gas flow by centrifugal separation.
